(19) United States
(12) Patent Application Publication
(10) Pub. No.: US 2007/0234053 A1
(43) Pub. Date: Oct. 4, 2007

(54) Information processing device and medium for the same

(75) Inventor: Yasuhiro Kudo, Ichinomiya (JP)

Correspondence Address: MCDERMOTT WILL & EMERY LLP, 600 13TH STREET, N.W., WASHINGTON, DC, 20005-3096, US

(73) Assignee: BROTHER KOGYO KABUSHIKI KAISHA

(21) Appl. No.: 11/727,684

(22) Filed: Mar. 28, 2007

(30) Foreign Application Priority Data
Mar. 30, 2006 (JP) 2006-093913

(51) Int. Cl. H04L 9/00

(52) U.S. Cl. 713/169

(57) ABSTRACT

An information processing device configured to perform communication with at least one external device via a network comprises a receiving system configured to receive an electronic certificate transmitted by the at least one external device, the electronic certificate including information on a validity period during which the electronic certificate is valid, a time measuring system configured to measure a current time, an error determining system configured to determine an error of the current time measured by the time measuring system; and a judging system configured to judge whether the electronic certificate received by the receiving system is invalid based on the information on the validity period included in the electronic certificate, the current time measured by the time measuring system, and the error of the current time determined by the error determining system.

### CROSS-RELATED TO RELATED APPLICATIONS

This application claims priority under 35 U.S.C. §119 from Japanese Patent Application No. 2006-093913, filed on Mar. 30, 2006. The entire subject matter of the application is incorporated herein by reference.

### BACKGROUND

1. Technical Field

The following description relates to one or more techniques that can provide high-security encrypted communication using an electronic certificate.

2. Related Art

Along with wide use of the Internet, an encrypted communication technology using an electronic certificate has been put to practical use to improve security when using the Internet.

In general, a validity period is set for the electronic certificate from the aforementioned viewpoint. Further, there have been proposed technologies to accurately manage the validity period.

For example, there is proposed a technology in which, when an SSL (Secure Socket Layer) communication is performed between a mobile phone and an IP server via a gateway server that accurately measures a current time, the mobile phone acquires time information on the accurate current time from the gateway server, sets a time based on the time information as a current time for itself, and decrypts a public key certificate transmitted by the IP server as the other communication party (an electronic certificate issued for a public key of the IP server by a proper CA (Certificate Authority)) with a public key of the CA, so as to check the validity period of the public key certificate with the current time for itself (the time based on the accurate current time measured by the gateway server) (for example, see Japanese Patent Provisional Publication No. 2002-186037).

However, in the aforementioned technology, it is required to inquire at an external device (gateway server) for the current time every time the encrypted communication is performed.

In the meantime, an information processing device employed for utilizing the Internet has a built-in clock. However, a measurement error caused by the built-in clock provided to an information processing device of this sort might be so large that it is impossible to accurately manage the validity period. In addition, the built-in clock is provided with a function for manually adjusting the time so that a user can be free to adjust the time. For this reason, when the user intentionally changes the time indicated by the built-in clock, it might cause an improper use of the electronic certificate that is actually expired (for example, Japanese Patent Provisional Publication No. 2004-21882).

### SUMMARY

Aspects of the present invention are advantageous in that there can be provided one or more improved information processing devices that make it possible to perform high-security data communication even though it is difficult for the information processing device to accurately measure a current time.

### BRIEF DESCRIPTION OF THE ACCOMPANYING DRAWINGS

FIG. 1 schematically shows a configuration of a network system in accordance with one or more aspects of the present invention.

FIG. 2 is a flowchart showing a process for setting a built-in clock provided to a printer or a PC in accordance with one or more aspects of the present invention.

FIG. 3 schematically shows encrypted communication for two-way authentication that is to be performed between the printer and PC in accordance with one or more aspects of the present invention.

FIG. 4 schematically shows a configuration of an electronic certificate in accordance with one or more aspects of the present invention.

FIG. 5 is a flowchart showing a process to be executed when receiving the electronic certificate in accordance with one or more aspects of the present invention.

### DETAILED DESCRIPTION

It is noted that various connections are set forth between elements in the following description. It is noted that these connections in general and, unless specified otherwise, may be direct or indirect and that this specification is not intended to be limiting in this respect. Aspects of the invention may be implemented in computer software as programs storable on computer-readable media including but not limited to RAMs, ROMs, flash memory, EEPROMs, CD-media, DVD-media, temporary storage, hard disk drives, floppy drives, permanent storage, and the like.

General Overview

According to aspects of the present invention, there is provided an information processing device configured to perform communication with at least one external device via a network, which includes a receiving system configured to receive an electronic certificate transmitted by the at least one external device, the electronic certificate including information on a validity period during which the electronic certificate is valid, a time measuring system configured to measure a current time, an error determining system configured to determine an error of the current time measured by the time measuring system, and a judging system configured to judge whether the electronic certificate received by the receiving system is invalid based on the information on the validity period included in the electronic certificate, the current time measured by the time measuring system, and the error of the current time determined by the error determining system.

According to some aspects, the information processing device can judge whether the electronic certificate transmitted by an external device via the network is valid based on the information on the validity period included in the electronic certificate, the current time measured by the time measuring system, and the error of the current time determined by the error determining system. Therefore, it is possible to perform high-security data communication, even though it is difficult for the information processing device to accurately measure the current time.

Optionally, the information processing device may further include a forbidding system configured to forbid the communication with the at least one external device when the judging system judges that the electronic certificate is invalid.

According to some aspects, when the electronic certificate transmitted by the external device via the network is judged invalid in view of the validity period thereof, the communication with the external device is forbidden. Therefore, it is possible to perform data communication of higher security, even though it is difficult for the information processing device to accurately measure the current time.

Optionally, the information processing device may further include a parameter acquiring system configured to acquire parameters to be used for determining the error of the current time. In this case, the error determining system may be configured to determine the error of the current time based on the parameters acquired by the parameter acquiring system.

Yet optionally, the information processing device may further include at least one time setting system configured to set the current time to be measured by the time measuring system. Furthermore, the parameter acquiring system may be configured to acquire the parameters to be used for determining the error of the current time depending on a time setting system to be utilized to set the current time among the at least one time setting system.

Still optionally, the parameters acquired by the parameter acquiring system may include a setting time and an error of the setting time at a moment when the time setting system has set the current time to be measured by the time measuring system. Further optionally, the error determining system may be configured to determine the error of the current time based on the setting time, the error of the setting time, and an accuracy of the time measuring system.

According to some aspects, it is possible to adequately improve the security of the data communication depending on the accuracy of the current time measured by the time measuring system.

Optionally, the judging system may be configured to judge that the electronic certificate received by the receiving system is valid when a current time period defined with a first time obtained by subtracting the error of the current time from the current time and a second time obtained by adding the error of the current time to the current time is within the validity period of the electronic certificate.

Optionally, the judging system may be configured to judge that the electronic certificate received by the receiving system is valid when a current time period defined with a first time obtained by subtracting the error of the current time from the current time and a second time obtained by adding the error of the current time to the current time is out of the validity period of the electronic certificate.

Optionally, the judging system may be configured to entrust a user to judge whether the electronic certificate received by the receiving system is valid when a part of a current time period defined with a first time obtained by subtracting the error of the current time from the current time and a second time obtained by adding the error of the current time to the current time is within the validity period of the electronic certificate.

According to some aspects, the information processing device can judge whether the electrical certificate transmitted by the external device is valid by checking whether the current time period defined with the first time obtained by subtracting the error of the current time from the current time and the second time obtained by adding the error of the current time to the current time is within the validity period of the electronic certificate. Therefore, it is possible to perform data communication of higher security, even though it is difficult for the information processing device to accurately measure the current time.

Further, according to some aspects, when it is difficult to judge whether the electronic certificate is valid in view of the measured current time, the determined error of the current time, and the validity period of the electronic certificate, it is possible to entrust the judgment to the user. Thereby, the information processing device makes it possible to flexibly meet the case where it is difficult to judge whether the electronic certificate is valid so as to assure the high-security data communication.

According to another aspect of the present invention, there is provided an information processing device configured to perform communication with at least one external device via a network, which includes a receiving system configured to receive an electronic certificate transmitted by the at least one external device, the electronic certificate including information on a validity period during which the electronic certificate is valid; a time measuring system configured to measure a current time, a plurality of time adjusting systems configured to adjust the current time to be measured by the time measuring system, the plurality of time adjusting systems including a first time adjusting system, a checking system configured to check which time adjusting system, among the plurality of time adjusting systems, has adjusted the current time measured by the time measuring system, an error determining system configured to determine a first error as an error of the current time measured by the time measuring system when the checking system judges that the first time adjusting system has adjusted the current time, a judging system configured to judge whether the electronic certificate received by the receiving system is invalid based on the information on the validity period included in the electronic certificate, the current time measured by the time measuring system, and the first error of the current time determined by the error determining system when the checking system judges that the first time adjusting system has adjusted the current time, and a forbidding system configured to forbid the communication with the at least one external device when the judging system judges that the electronic certificate is invalid.

According to some aspects, it is possible to perform high-security data communication, even though it is difficult for the information processing device to accurately measure the current time.

Optionally, the error determining system may be configured to determine the error of the current time measured by the time measuring system depending on a time adjusting system judged by the checking system to have adjusted the current time among the plurality of time setting systems. In this case, the judging system may be configured to judge whether the electronic certificate received by the receiving system is invalid based on the information on the validity period included in the electronic certificate, the current time measured by the time measuring system, and the error of the current time determined by the error determining system.

According to some aspects, it is possible to adequately improve the security of the data communication depending on the time adjusting system to be utilized to adjust the current time measured by the time measuring system.

According to a further aspect of the present invention, there is provided a computer usable medium having computer readable instructions stored thereon, which, when executed by a processor included in a computer configured to perform communication with at least one external device via a network, cause the processor to perform steps of receiving an electronic certificate transmitted by the at least one external device, the electronic certificate including information on a validity period during which the electronic certificate is valid, measuring a current time, determining the error of the current time measured in the step of measuring the current time, and judging whether the electronic certificate received in the step of receiving the electronic certificate is valid based on the information on the validity period included in the electronic certificate, the current time measured in the step of measuring the current time, and the error of the current time determined in the step of determining the error of the current time.

According to the computer usable medium configured as above, the same effects as the aforementioned information processing device can be expected.

Illustrative Aspects

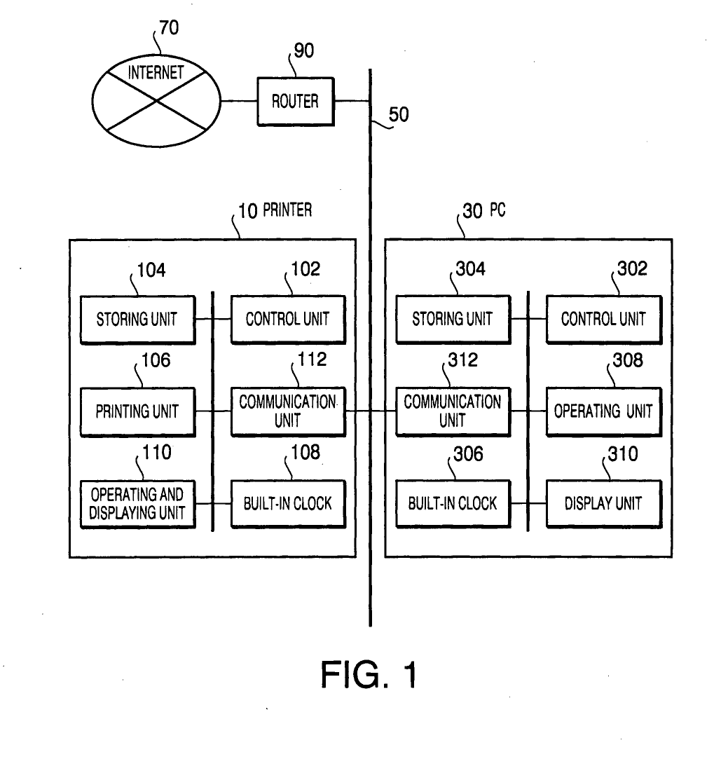

Hereinafter, an embodiment according to aspects of the present invention will be described with reference to the accompanying drawings. FIG. 1 schematically shows a configuration of a network system that includes a printer 10 and a personal computer (hereinafter, simply referred to as a “PC”) 30 that sends printing data to the printer 10 so as to give the printer 10 a printing instruction.

The printer 10 includes a control unit 102 configured with a CPU to control the printer 10, a RAM, and a ROM, a storing unit 104 such as a hard disk drive and a flash memory that stores various data including the below-mentioned electronic certificate therein, a printing unit 106 that performs a printing operation based on the printing data sent by the PC 30, a built-in clock 108 that measures a current time, an operating and displaying unit 110 configured such that a predetermined instruction for the printer 10 is inputted therethrough and such that there is displayed thereon predetermined information regarding the printer 10, and a communication interface (hereinafter, referred to as a “communication I/F”) 112 directly connected with a LAN (Local Area Network) 50.

The PC 30 includes a control unit 302 configured with a CPU to control the PC 30, a RAM, and a ROM, a storing unit 304 such as a hard disk drive and a flash memory that stores various data including the below-mentioned electronic certificate therein, a built-in clock 306 that measures a current time, an operating unit 308 through which various data are inputted, a display unit that displays various information thereon, and a communication interface (hereinafter, referred to as a “communication I/F”) 312 directly connected with the LAN 50.

In addition, the printer 10 and the PC 30 are communicably connected with each other via the LAN 50, and are connected with an external so-called Internet 70 via a router. It is noted that there is present on the Internet 70 a so-called time server (not shown) that can provide current time information to various devices communicably connected with the Internet.

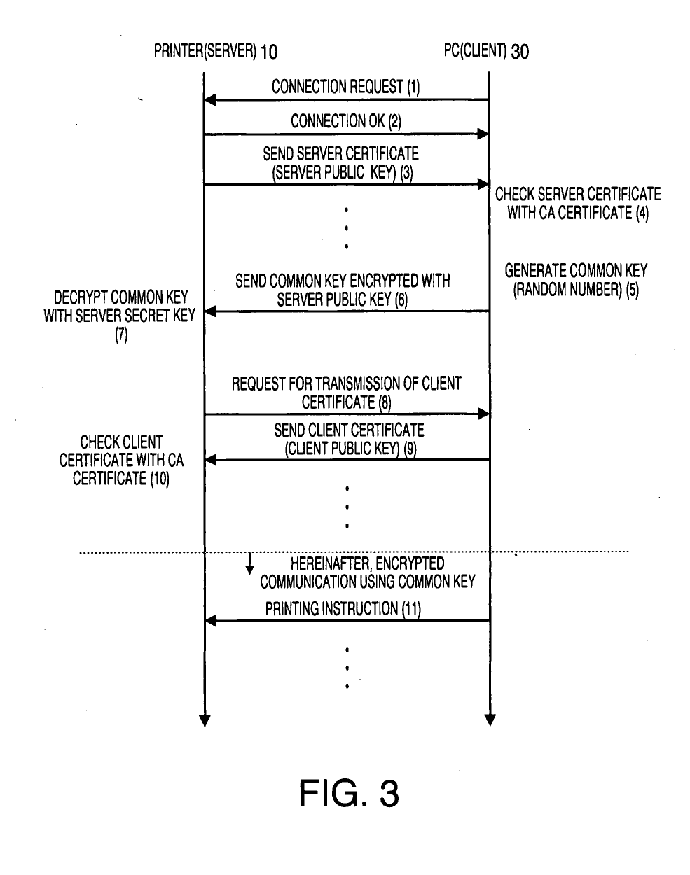

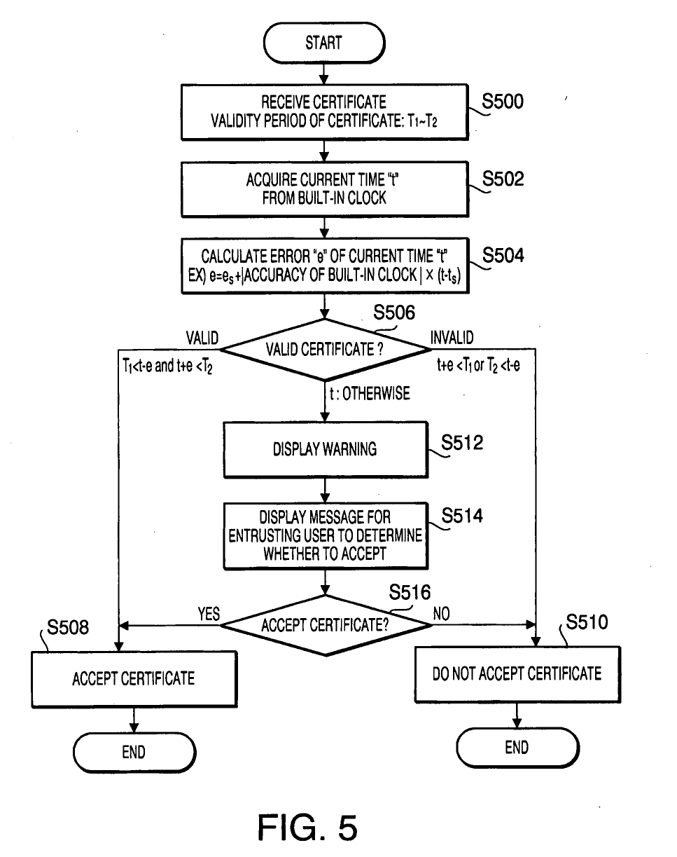

Each of various processes to be executed by the printer 10 or the PC 30, which include processes shown in FIGS. 3 and 5, is performed by the CPU included in the control unit 102 or 302 based on a program associated with each of the various processes that is stored in a corresponding one of the ROMs and various data stored in the storing unit 104 or 304.

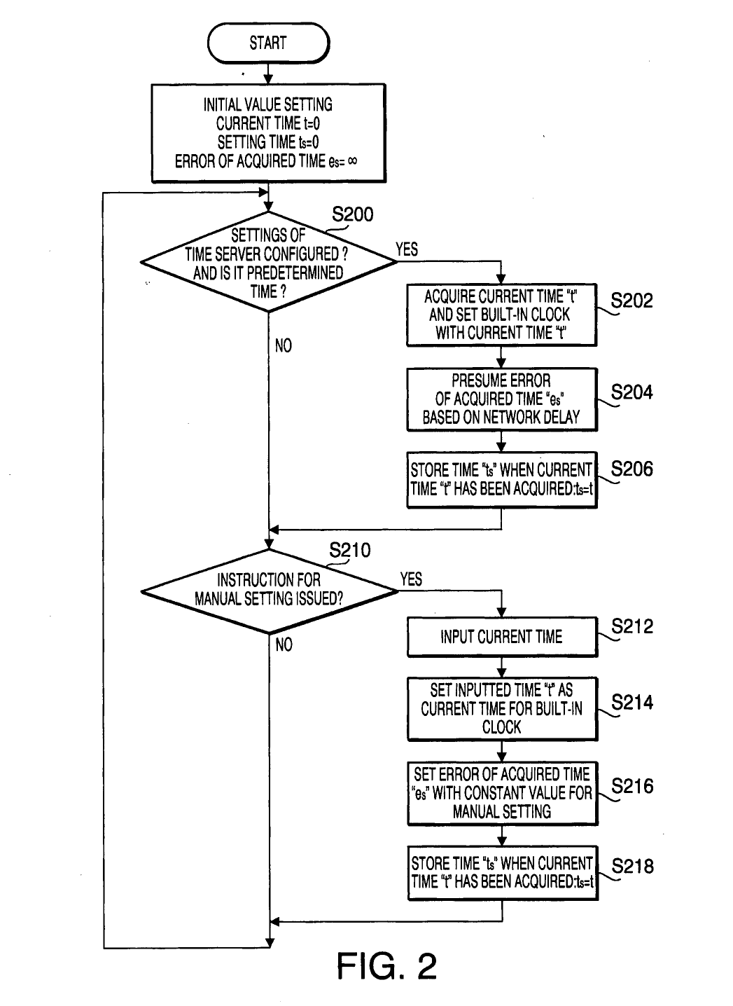

FIG. 2 is a flowchart showing a process to be executed by the printer 10 or the PC 30 in parallel with other processes, when setting the built-in clock 108 or 306 provided to the printer 10 or the PC 30.

It is noted that the same process as shown in FIG. 2 is executed by each of the control unit 102 of the printer 10 and the control unit 302 of the PC 30. Hereinafter, an explanation will be given in case of the printer 10.

Firstly, the control unit 102 judges whether settings of the time server to be used for setting (adjustment) of the built-in clock 108 have already been configured, and whether it is predetermined time for executing time setting with the time server (S200).

It is noted that the aforementioned steps of S202 to S206 that include a process for setting the built-in clock with the current time are automatically performed at a predetermined time or every predetermined time interval.

Then, when it is judged that the settings of the time server have already been configured and it is the predetermined time (S200: Yes), the steps of S202 to S206 are performed. Meanwhile, when it is not judged that the settings of the time server have already been configured, or when it is not judged to be the predetermined time (S200: No), the process directly proceeds to S210. Further, when it is judged that an instruction for manual setting of the current time has been issued from the user (S210: Yes), the process proceeds to S212.

It is noted that initial settings of the time server are configured with default values stored into the printer 10 before shipping or with initial values set by the user when setting up the printer 10.

In S202, the control unit 102 accesses the time server to acquire current time “t”, and sets the current time measured by the built-in clock with the acquired current time “t”. Then, the process proceeds to S204.

In S204, the accuracy of the current time “t” acquired from the time server in S202 (namely, an error of the acquired time “eₛ”) is presumed, for example, based on network delay. Then, the presumed error value “eₛ” is stored to update an initial value or a value stored in the previous corresponding step as the accuracy of the current time therewith. Thereafter, the process goes to S206.

It is noted that, in the below-mentioned process shown in FIG. 5, when there is applied a policy that the error of the current time set with the value acquired from the time server is very small and negligible, the error “eₛ” can be regarded to be zero.

In S206, there is stored as a start time “tₛ” of the process (hereinafter, referred to as a “setting time”) a time when the current time “t” has been acquired in S202, so as to update a value stored in the previous corresponding step therewith.

In addition, the control unit 102 judges whether the instruction for the manual setting of the built-in clock 108 has been issued through the operating and displaying unit 110 (S210).

Then, when it is judged in S210 that the instruction for the manual setting of the built-in clock 108 has been issued (S210: Yes), steps of S212 to S218 are performed. Meanwhile, when it is not judged that the instruction for the manual setting of the built-in clock 108 has been issued (S210: No), the control unit 102 keeps waiting ready until the next predetermined time for executing the time setting with the time server comes or until the control unit 102 receives the instruction for the manual setting of the built-in clock 108.

In S212, the operating and displaying unit 110 displays the time measured by the built-in clock 108 thereon, and accepts an input of a current time through the operating and displaying unit. Thereafter, the process proceeds to S214.

In S214, the inputted time is set as the current time measured by the built-in clock 108 by an operation for fixing the inputted time that is performed through the operating and displaying unit 110 after the input of the current time in the step of S212. Then, the process goes to S216.

In S216, a predetermined value is stored as an error “eₛ” of the current time acquired by the manual setting so as to update a value stored in the previous setting operation therewith. Thereafter, the process proceeds to S218.

In S218, a time measured by the built-in clock 108 at a moment when the instruction for the manual setting of the built-in clock 108 has been issued (namely, the time displayed as the initial value in S212) is stored as the setting time “tₛ” to update a value stored in the previous corresponding setting. Then, the manual setting procedure is terminated, and as aforementioned, the control unit 102 keeps waiting ready until the next predetermined time for executing the time setting with the time server comes or until the control unit 102 receives the instruction for the manual setting of the built-in clock 108 again.

It is noted that, in the aforementioned process, when the setting for the built-in clock 108 is not performed, or when the stored information regarding the setting for built-in clock 108 is initialized, the current time “t” and the setting time “tₛ” are set as initial settings, respectively, with “00 [day]/00 [month]/2006 [year], 00 [hour]:00 [minute]:00 [second]” and “**[day]/**[month]/****[year], **[hour]:**[minute]:**[second]” (“*” means a state where a corresponding value is not set). Further, the error of the acquired time “eₛ” is set with an initial value of infinite.

FIG. 3 schematically shows encrypted communication for two-way authentication (namely, communication in accordance with an SSL handshake) that is to be previously performed between the PC 30 and the printer 10 before the PC 30 causes the printer 10 to execute a printing operation.

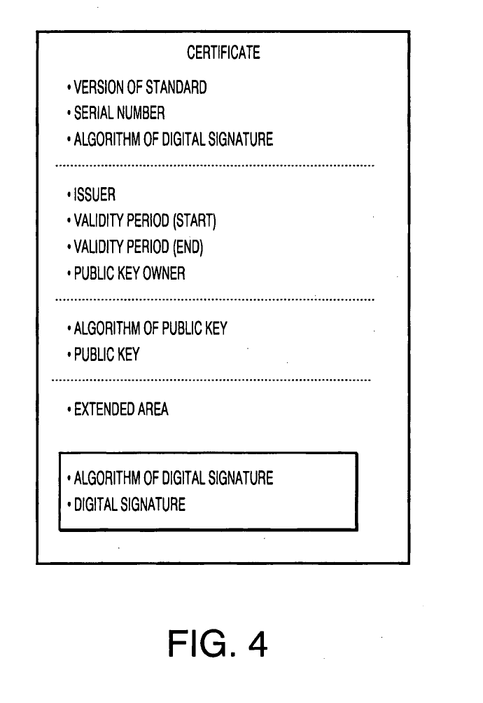

The encrypted communication is automatically started at the side of PC 30, for example, based on information displayed on the display unit 310, with a printer driver to control the printer 30 that is stored in the storing unit 304, when the user instructs the printer 10 to perform the printing operation. Additionally, the encrypted communication is performed with a certificate issued by a CA (Certificate Authority) (hereinafter, referred to as a “CA certificate”), server certificate, and client certificate, each of which is stored in the storing unit 104 or 304 (see FIG. 4).

It is noted that each number between marks “(“and”)” written in the following explanation regarding FIG. 3 represents a corresponding number between marks “(“and”)” shown in FIG. 3.

Firstly, in response to the aforementioned printing instruction by the user, the encrypted communication is started with a connection request (1) issued by the PC 30 for connection with the printer 10 and a notification (2) that the printer 10 can be connected with the PC 30 that is issued by the printer 10 in response to the connection request (1).

It is noted that, in the connection request (1), the PC 30 informs the printer 10 of available encrypted communication methods. Meanwhile, in the notification (2), the printer 10 informs the PC 10 of an encrypted communication method to be applied.

Subsequently, the server certificate that includes a signature by a predetermined CA and a public key of the printer 10 is sent from the printer 10 to the PC 30 (3). It is noted that the signature by the CA is encrypted with a secret key of the CA.

Then, the PC 30 that has received the server certificate checks the server certificate sent from the printer 10 by decrypting the signature included in the server certificate with the CA certificate (the public key, i.e., a certificate (public key) of the same CA as the aforementioned “predetermined CA”) that has previously been stored in the storing unit 304 (4).

In addition, when the PC 30 confirms as a result of the checking operation (4) that the printer 10 that has sent the server certificate is the printer 10 that the PC 30 has instructed to perform the printing operation, the PC 30 generates a common key (random number) utilized for communication of printing data (5). Then, the PC 30 decrypts the common key with the public key of the printer 10 as previously received (see the aforementioned (3)), and sends the decrypted common key to the printer 10 (6).

The printer 10 decrypts the common key sent from the PC 30 in the transmission (6) with the secret key stored in the storing unit 104 that corresponds to the public key sent to the PC 30 in the transmission (3) (7).

Further, the printer 10 issues a request for the PC 30 to send the client certificate so as to authenticate the PC 30 that will send the printing data to the printer 10 in the following communication (8). The PC 30 that has received the request sends, to the printer 10, the client certificate (including the public key of the PC 30) that has previously been installed in the storing unit 304.

Then, the printer 10 that has received the client certificate checks the client certificate sent from the PC 30 by decrypting a signature included in the client certificate with the CA certificate (public key) stored in the storing unit 104 that is the certificate of the CA which has given the signature to the client certificate (10).

Namely, by the aforementioned steps, the PC 30 and the printer 10 have the common key used for the communication of the printing data in common, since the PC 30 authenticates the printer 10 (see the aforementioned steps (3) and (4)) and the printer 10 authenticates the PC 30 (see the aforementioned steps (9) and (10)).

Thereafter, the PC 30 encrypts the printing data with the common key, and then sends the encrypted printing data to the printer 10, so that the printing operation can be performed. It is noted that an explanation regarding the printing operation will be omitted.

FIG. 5 is a flowchart showing a process performed in the steps (4) and (10) shown in FIG. 3, namely, a process of accepting (checking) the server certificate and client certificate that are mutually transmitted. It is noted that the same process is applied in both of the printer 10 and PC 30 as a process to be executed by the control units 102 and 302. Hereinafter, an explanation regarding the process will be given to take the printer 10 as an example (namely, based on the process in the aforementioned step (10)).

Firstly, the control unit 102 detects a start time “T1” and an end time “T2” of a validity period included in the client certificate (S500), and thereafter, acquires the current time “t” measured by the built-in clock 108 (S502). Then, the process proceeds to S504.

In S504, the control unit 102 calculates the error of the current time “t” measured by the built-in clock 108, and then, the process goes to S506.

Here, it is noted that the error “e” in S504 is calculated in accordance with an error calculation rule (e.g., an equation written in S504 shown in FIG. 5 as an example) stored in the storing unit 104.

Specifically, to give an explanation on how to calculate the error “e”, when the current time of the built-in clock 108 is set using the time server (it is judged based on the error of the acquired time “eₛ” whether the current time of the built-in clock 108 is set using the time server or by the manual setting), the error is determined based on each of the values stored in the steps S204 and S206 shown in FIG. 2, the current time measured by the built-in clock 108, and the accuracy of the built-in clock 108. Namely, based on an assumption of 0 seconds as the error of the acquired time “eₛ”, ±30 seconds/30 days as the accuracy of the built-in clock 108, Mar. 14, 2006, 12:00:00 as the current time “t”, Feb. 12, 2006, 12:00:00 as the setting time “tₛ”, the error “e” is determined to be 30 seconds.

Meanwhile, when the current time of the built-in clock 108 is set by the manual setting, the error is determined based on each of the values stored in the steps S216 and S218 shown in FIG. 2, the current time measured by the built-in clock 108, and the accuracy of the built-in clock 108. Namely, based on an assumption of 12 hours (43,200 seconds) as the error Mar. 14, 2006, 12:00:00 as the current time “t”, Feb. 12, 2006, 12:00:00 as the setting time “tₛ”, the error “e” is determined to be 43,230 seconds (12 hours and 30 seconds).

It is noted that, according to the aforementioned calculation rule, since the error “e” is determined in consideration of the accuracy of the built-in clock 108 and the elapsed time after the previous setting, it is possible to more accurately determine the error of the current time measured by the built-in clock 108.

On the contrary, the error “e” may be determined, without consideration of the accuracy of the built-in clock 108 and the elapsed time after the previous setting, only based on the error of the acquired time “eₛ” depending on the method to adjust the current time (in this case, the error “e” is identical to the error of the acquired time “eₛ”. Further, as aforementioned, if the error of the acquired time “eₛ” is regarded to be zero when adjusting the current time using the time server, it is not necessary to consider the error “e”). In addition, the error “e” may be determined only in consideration of the accuracy of the built-in clock 108 and the elapsed time after the previous setting. In these cases, the configuration (process) can be simplified.

In S506, based on the current time “t” acquired in S502 and the error “e” determined in S504, it is judged whether the client certificate is valid in view of the validity period thereof. In other words, it is judged whether a current time period defined with a first time of “t−e” obtained by subtracting the error “e” determined in S504 from the current time “t” acquired in S502 and a second time of “t+e” obtained by adding the error “e” to the current time “t” is within the validity period (from the start time “T1” to the end time “T2”) included in the client certificate.

Specifically, when the judgment in S506 is affirmative (S506: Valid), the printer 10 accepts the client certificate sent by the PC 10, and then, the subsequent steps (the steps following the step (11) in FIG. 2) are performed (S508).

Meanwhile, when the client certificate is judged invalid in S506, namely, when the current time period is out of the validity period (S506: Invalid), the printer 10 does not accept the client certificate sent by the PC 30, and carries out a step of displaying an error message on the operating and displaying unit 110 (S510). It is noted that, in this case, since the printer 10 informs the PC 30 that the client certificate is invalid in view of the validity period and causes the PC 30 that has received the above information to display the information on the display unit 310 of the PC 30, it is preferred that it is possible to induce the user of the PC 30 to update the client certificate.

In this manner, when the printer 10 (or the PC 30) of the embodiment can acquire the accurate current time from the time server, the error “e” of the built-in clock 108 (the built-in clock 306 in case of the PC 30) is regarded to be negligibly small, and it is accurately judged whether the client certificate (the server certificate in case of the PC 30) is valid in view of the validity period thereof. Meanwhile, when it is difficult to acquire the accurate current time as the case of the manual setting, the error “e” is set large such that the printer 10 (a device that checks the electronic certificate transmitted by the other device) can make a safer judgment on whether the client certificate is valid in view of the validity period. Thereby, it is possible to assure high-security data communication.

Here, when the client certificate sent by the PC 30 is not judged valid in view of the validity period in S506, yet especially, when the acquired current time is within the validity period (S506: Otherwise), the client certificate may not be judged invalid without exception in view of the validity period. In this case, the process goes to S512 after the step of S506 has been completed.

Firstly, in S512, the control unit 102 displays a warning that the client certificate may be invalid in view of the validity period thereof on the operating and displaying unit 110. Then, after displaying the warning during a predetermined period, or with displaying the warning, the control unit 102 displays a message for entrusting the user to determine whether to accept the client certificate (S514).

Then, when, according to the displayed message in S514, the user of the printer 10 (who is essentially different from the user who has issued the printing instruction from the PC 30) issues an instruction to accept the client certificate via the operating and displaying unit 110 (S516: Yes), the process goes to S508. Meanwhile, when the user of the printer 10 issues an instruction not to accept the client certificate (S516: No), the process goes to S510.

Further, in S506, when a part of the aforementioned current time period is within the validity period (S506: Otherwise), the printer 10 may be configured such that the PC 30 cannot utilize all of the functions provided to the printer 10, yet can utilize a part of the functions. For example, when the printer 10 is provided with functions of color printing and black-and-white printing, the PC 30 can utilize the function of black-and-white printing.

Specifically, it the aforementioned case (S506: Otherwise), the process goes to S512.

In S512, the control unit 102 displays a message that when a part of the aforementioned current time period is within the validity period on the operating and displaying unit 110. Then, the control unit 102 displays, on the operating and displaying unit 110, a message for entrusting the user to judge whether to accept the client certificate and establish the restricted communication (S514).

Subsequently, when the user issues an instruction to accept the client certificate in S516 (S516: Yes), the process goes to S508. Meanwhile, when the user issues an instruction to establish the restricted communication and not to accept the client certificate (S516: No), the process proceeds to S510.

Hereinabove, in the aforementioned embodiment, the concrete process to be executed by the printer 10 has been explained based on the client certificate sent by the device to be communicated with. However, the PC 30 that is to send the client certificate may judge whether the client certificate is valid prior to the transmission of the client certificate (see the step (9) in FIG. 3) with a technology configured as aforementioned.

In this case, the control unit 302 of the PC 30 performs the process as shown in FIG. 2 when setting the built-in clock 306, and performs the process as shown in FIG. 5 before transmitting the client certificate. When the judgment in S506 or S516 is negative, it is not allowed to send the client certificate. Thereby, the encrypted communication between the printer 10 and the PC 30 is not prevented after the judgment.

It is noted that the printer 10 can be configured to perform the same processes as the PC 30 described as aforementioned prior to the transmission of the server certificate.

The present invention can be practiced by employing conventional materials, methodology and equipment. Accordingly, the details of such materials, equipment and methodology are not set forth herein in detail. In the previous descriptions, numerous specific details are set forth, such as specific materials, structures, chemicals, processes, etc., in order to provide a thorough understanding of the present invention. However, it should be recognized that the present invention can be practiced without resorting to the details specifically set forth. In other instances, well known processing structures have not been described in detail, in order not to unnecessarily obscure the present invention.

Only exemplary embodiments of the present invention and but a few examples of its versatility are shown and described in the present disclosure. It is to be understood that the present invention is capable of use in various other combinations and environments and is capable of changes or modifications within the scope of the inventive concept as expressed herein.

What is claimed is:

1. An information processing device configured to perform communication with at least one external device via a network, comprising:
a receiving system configured to receive an electronic certificate transmitted by the at least one external device, the electronic certificate including information on a validity period during which the electronic certificate is valid;
a time measuring system configured to measure a current time;
an error determining system configured to determine an error of the current time measured by the time measuring system; and
a judging system configured to judge whether the electronic certificate received by the receiving system is invalid based on the information on the validity period included in the electronic certificate, the current time measured by the time measuring system, and the error of the current time determined by the error determining system.

2. The information processing device according to claim 1, further comprising a forbidding system configured to forbid the communication with the at least one external device when the judging system judges that the electronic certificate is invalid.

3. The information processing device according to claim 1, further comprising a parameter acquiring system configured to acquire parameters to be used for determining the error of the current time, and
wherein the error determining system is configured to determine the error of the current time based on the parameters acquired by the parameter acquiring system.

4. The information processing device according to claim 3, further comprising at least one time setting system configured to set the current time to be measured by the time measuring system, and
wherein the parameter acquiring system is configured to acquire the parameters to be used for determining the error of the current time depending on a time setting system to be utilized to set the current time among the at least one time setting system.

5. The information processing device according to claim 4,
wherein the parameters acquired by the parameter acquiring system include a setting time and an error of the setting time at a moment when the time setting system has set the current time to be measured by the time measuring system, and
wherein the error determining system is configured to determine the error of the current time based on the setting time, the error of the setting time, and an accuracy of the time measuring system.

6. The information processing device according to claim 1,
wherein the judging system is configured to judge that the electronic certificate received by the receiving system is valid when a current time period defined with a first time obtained by subtracting the error of the current time from the current time and a second time obtained by adding the error of the current time to the current time is within the validity period of the electronic certificate.

7. The information processing device according to claim 1,
wherein the judging system is configured to judge that the electronic certificate received by the receiving system is valid when a current time period defined with a first time obtained by subtracting the error of the current time from the current time and a second time obtained by adding the error of the current time to the current time is out of the validity period of the electronic certificate.

8. The information processing device according to claim 1,
wherein the judging system is configured to entrust a user to judge whether the electronic certificate received by the receiving system is valid when a part of a current time period defined with a first time obtained by subtracting the error of the current time from the current time and a second time obtained by adding the error of the current time to the current time is within the validity period of the electronic certificate.

9. An information processing device configured to perform communication with at least one external device via a network, comprising:
a receiving system configured to receive an electronic certificate transmitted by the at least one external device, the electronic certificate including information on a validity period during which the electronic certificate is valid;
a time measuring system configured to measure a current time;
a plurality of time adjusting systems configured to adjust the current time to be measured by the time measuring system, the plurality of time adjusting systems including a first time adjusting system;
a checking system configured to check which time adjusting system, among the plurality of time adjusting systems, has adjusted the current time measured by the time measuring system;
an error determining system configured to determine a first error as an error of the current time measured by the time measuring system when the checking system judges that the first time adjusting system has adjusted the current time;
a judging system configured to judge whether the electronic certificate received by the receiving system is invalid based on the information on the validity period included in the electronic certificate, the current time measured by the time measuring system, and the first error of the current time determined by the error determining system when the checking system judges that the first time adjusting system has adjusted the current time; and
a forbidding system configured to forbid the communication with the at least one external device when the judging system judges that the electronic certificate is invalid.

10. The information processing device according to claim 9,
wherein the error determining system is configured to determine the error of the current time measured by the time measuring system depending on a time adjusting system judged by the checking system to have adjusted the current time among the plurality of time setting systems, and
wherein the judging system is configured to judge whether the electronic certificate received by the receiving system is invalid based on the information on the validity period included in the electronic certificate, the current time measured by the time measuring system, and the error of the current time determined by the error determining system.

11. A computer usable medium having computer readable instructions stored thereon, which, when executed by a processor included in a computer configured to perform communication with at least one external device via a network, cause the processor to perform steps of:
receiving an electronic certificate transmitted by the at least one external device, the electronic certificate including information on a validity period during which the electronic certificate is valid;
measuring a current time;
determining the error of the current time measured in the step of measuring the current time; and
judging whether the electronic certificate received in the step of receiving the electronic certificate is valid based on the information on the validity period included in the electronic certificate, the current time measured in the step of measuring the current time, and the error of the current time determined in the step of determining the error of the current time.
